(19) United States
(12) Patent Application Publication
(10) Pub. No.: US 2011/0113108 A1
(43) Pub. Date: May 12, 2011

(54) E-MAIL PROCESSING SYSTEM, METHOD, AND COMPUTER-READABLE RECORDING MEDIUM CONFIGURED TO STORE E-MAIL PROCESSING PROGRAM

(75) Inventor: Osamu NISHIKUBO, Kawasaki (JP)

(73) Assignee: FUJITSU LIMITED, Kawasaki-shi (JP)

(21) Appl. No.: 12/940,458

(22) Filed: Nov. 5, 2010

(30) Foreign Application Priority Data
Nov. 9, 2009 (JP) 2009-255992

(51) Int. Cl. G06F 15/16

(52) U.S. Cl. 709/206

(57) ABSTRACT

An e-mail processing system including a terminal device registered in a mailing list, and an e-mail delivery device that forwards a received e-mail directed to a mailing list address registered in the mailing list, the terminal device includes an identification unit that identifies a category of the forwarded e-mail from the e-mail delivery device based on information included in the forwarded e-mail, a display unit that displays the forwarded e-mail, and a control unit that determines a display mode of the forwarded e-mail in the display unit based on the identified category of the forwarded e-mail.

### CROSS-REFERENCE TO RELATED APPLICATION

This application is based upon and claims priority to prior Japanese Patent Application No. 2009-255992 filed on Nov. 9, 2009 in the Japan Patent Office, the entire contents of which are incorporated herein by reference.

### FIELD

Embodiments discussed herein relate to an e-mail processing system, method, and a computer-readable recording medium configured to store an e-mail processing program.

### BACKGROUND

In call center operations, full time operators deal with incoming calls including telephone inquiries or questions. As Information and Communication Technology (ICT) using the web improves, a question answering system on the web has been progressively replacing the telephone inquiry service in recent years.

Systems for displaying an e-mail address on inquiry pages of a website as contact information for inquiries and sending replies to questionnaires to an e-mail address as a destination for the inquiries and replies have been increasing. In the website providing information services at the individual level, a personal e-mail address may be used. And, the inquiry e-mails may be dealt with at the individual level without a dedicated system because the scale of the website is relatively small and the inquiry e-mails are not so many. Thus, in the website providing information services at the individual level, there is very low, if not zero, possibility of the individual failing to receive an e-mail or reply an e-mail.

On the other hand, when an e-mail address is used in a website providing information services for enterprise, an electronic commerce (e-commerce) site, or the like, it is probable that the large amount of the inquiry e-mails and the answers of questionnaires are sent and received on a global scale. In this case, it is desirable that the processing of the e-mails and the answers are distributed among a plurality of persons in charge because of difficulties associated with dealing with the e-mails and the answers using the personal e-mail address.

In the field of e-mail, an e-mail may be broadcasted to two or more persons who are registered in a mailing list address by constructing a mailing list server and using a mailing list address. The processing of the sent e-mail may be distributed among the plurality of persons in charge by using the mailing list function where the e-mail-broadcasting may be performed with a single e-mail address.

In general, when the mailing list server is constructed, the e-mail is simply broadcasted to destinations of the mailing list, possibly causing undesirable results for the call center operations. For example, difficulties arise in managing a response status that indicates which operator has sent the reply e-mail to the inquiry e-mail broadcasted by using the mailing list.

In order to manage and/or monitor a response status that indicates which operator has sent a reply e-mail to the inquiry e-mail, a method for managing the response status by a terminal device of each operator has been proposed because provision of the dedicated management system may not be efficient. In one related method, Simple Mail Transfer Protocol (SMTP) is utilized in which a unique acceptance number is given to a received e-mail in the mailing list server, and the received e-mail is broadcasted to the terminal device of each of the operators while a unique acceptance number is given to the reply e-mail in the terminal device of each of the operators. As a result, the method may be adapted to the call center operations.
[Patent Document] Japanese Laid-open Patent Publication No. 2008-003763

### SUMMARY

According to an aspect of the invention, an e-mail processing system including a terminal device registered in a mailing list, and an e-mail delivery device that forwards a received e-mail directed to a mailing list address registered in the mailing list, the terminal device includes an identification unit that identifies a category of the forwarded e-mail from the e-mail delivery device based on information included in the forwarded e-mail, a display unit that displays the forwarded e-mail, and a control unit that determines a display mode of the forwarded e-mail in the display unit based on the identified category of the forwarded e-mail.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a configuration diagram of an e-mail processing system according to one embodiment;

FIG. 2 is a block diagram of a client terminal device in FIG. 1;

FIG. 3 is a sequence diagram of e-mail acceptance operations in FIGS. 1 and 2;

FIG. 4 is a sequence diagram of neglect alarm operations in FIGS. 1 and 2;

FIG. 5 is an illustrative diagram of a display screen of an e-mail in the client terminal device in FIG. 2;

FIG. 6 is an illustrative diagram of the header of a newly arrived e-mail in FIGS. 1 to 4;

FIG. 7 is an illustrative diagram of the header of a reply e-mail in FIGS. 1 to 4;

FIG. 8 is an illustrative diagram of the header of a forward e-mail in FIGS. 1 to 4;

FIG. 9 is a flowchart of e-mail reception operations according to the embodiment;

FIG. 10 is a flowchart of operations when an acceptance button is clicked according to the embodiment;

FIG. 11 is a flowchart of neglect timer operations in FIG. 9;

FIG. 12 is an illustrative diagram of a display screen of the newly arrived e-mail in FIG. 9;

FIG. 13 is an illustrative diagram of the clicking of the acceptance button in FIG. 10;

FIG. 14 is an illustrative diagram of a display screen of an acceptance confirmation e-mail;

FIG. 15 is an illustrative diagram of a display screen of a reply e-mail in FIG. 9; and

FIG. 16 is an illustrative diagram of a display screen of a request for the acceptance operations in FIGS. 9 and 11.

### DESCRIPTION OF EMBODIMENTS

### E-Mail Processing System

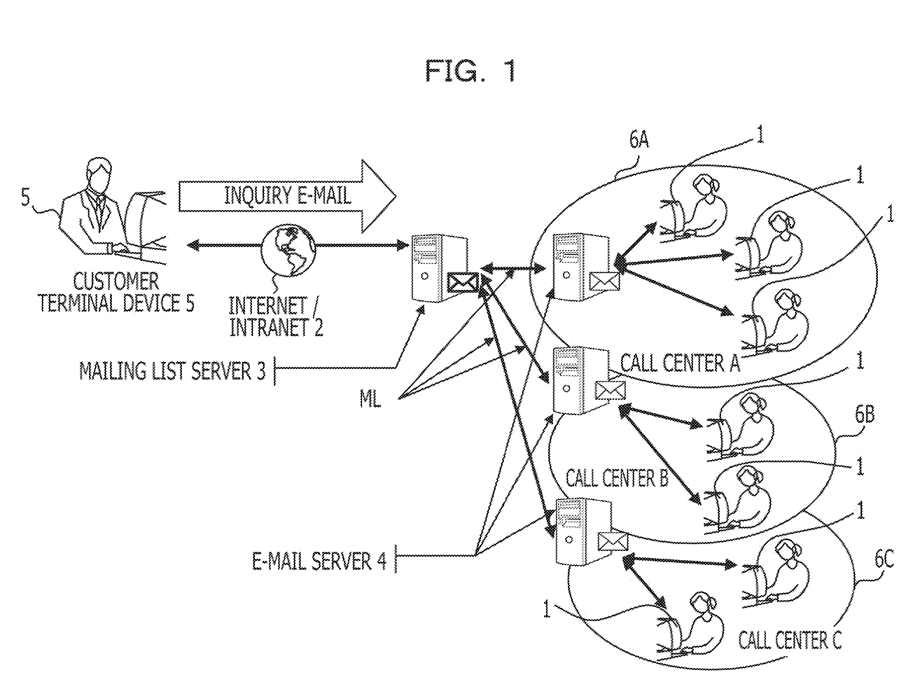

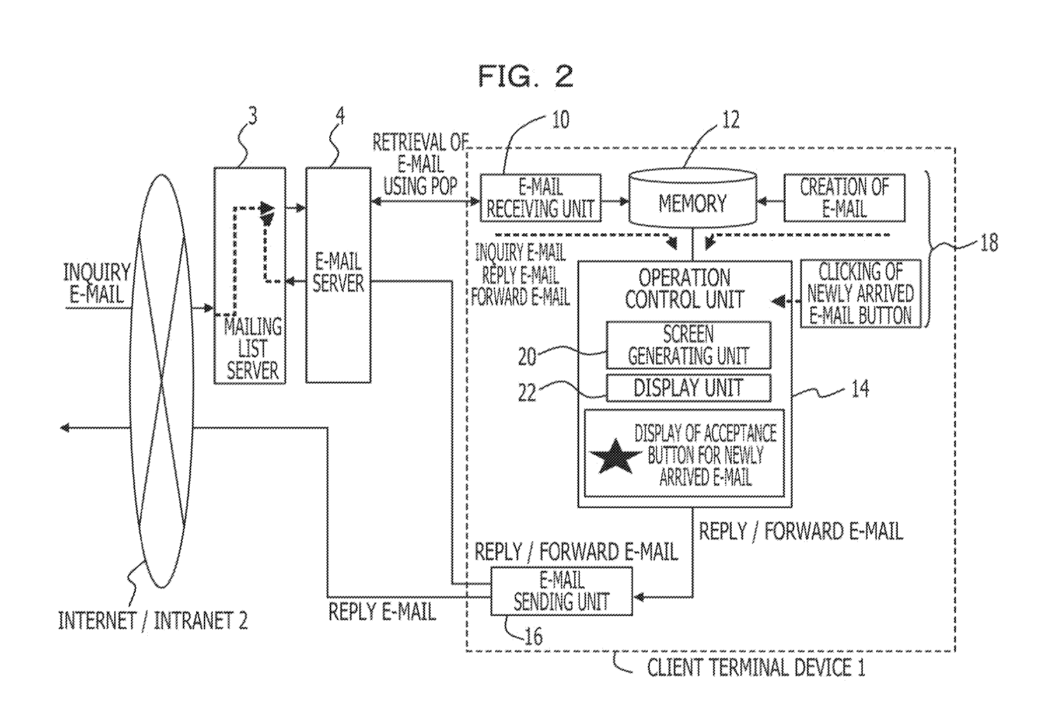

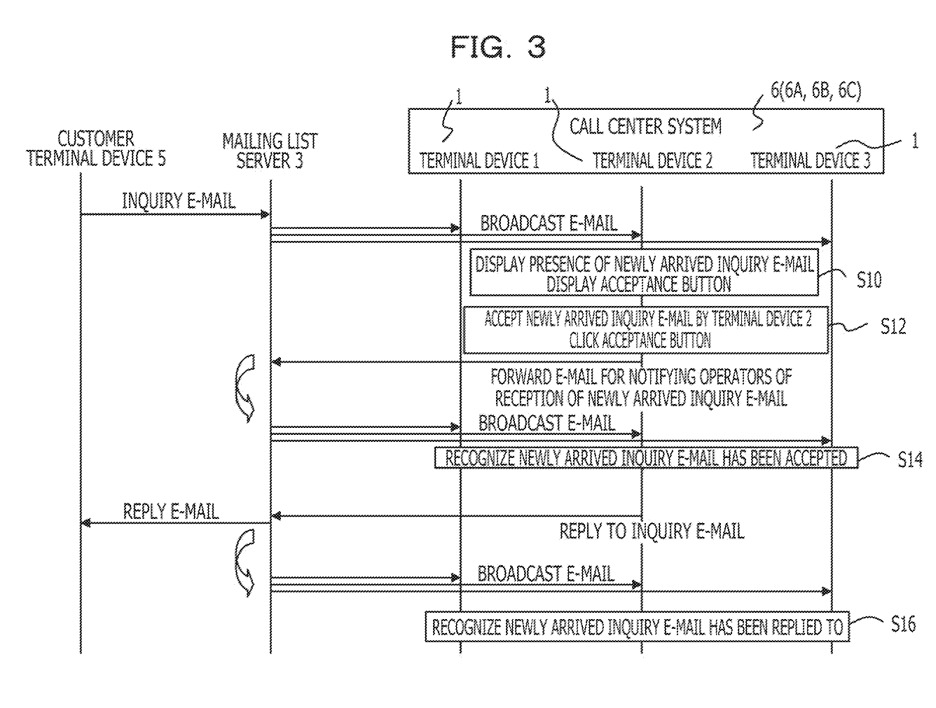

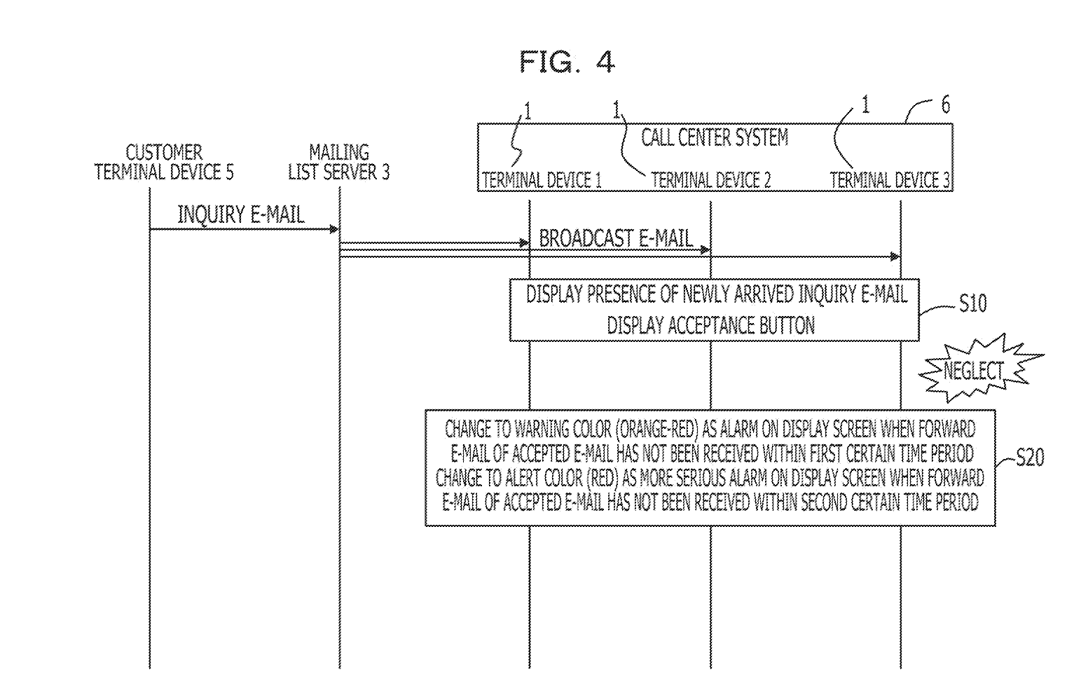

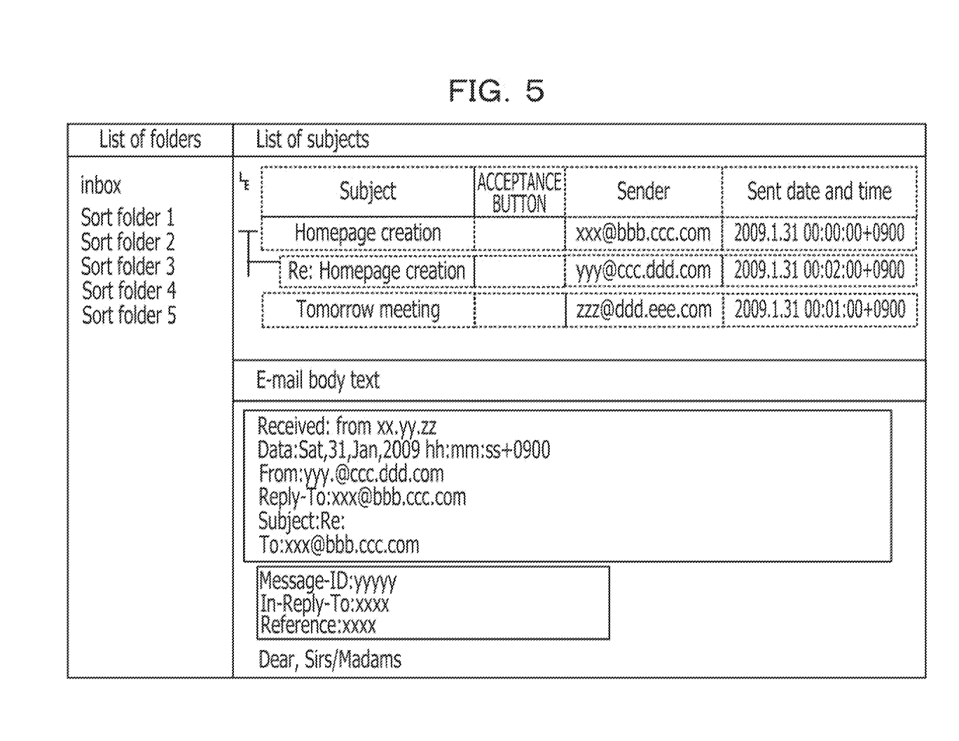

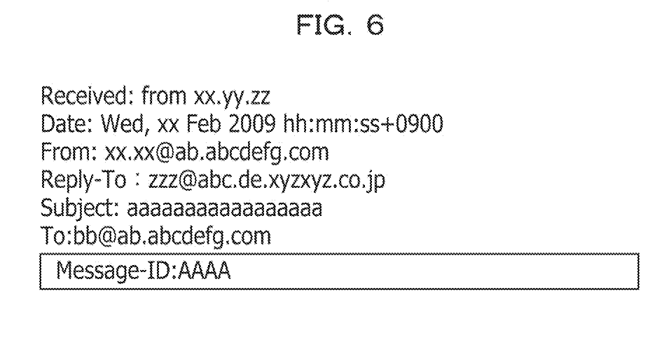

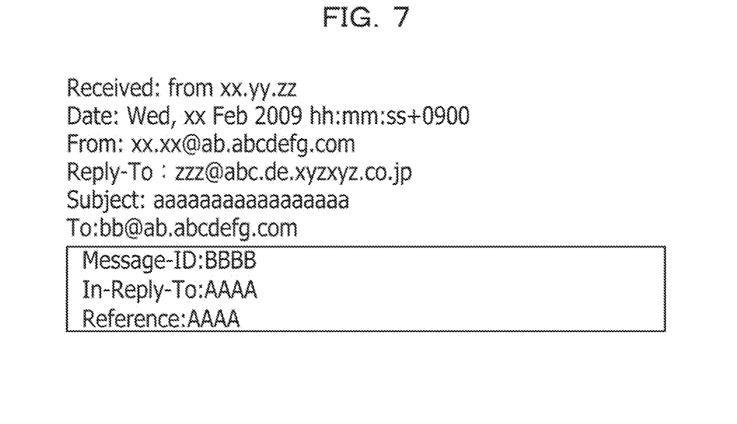

FIG. 1 is a configuration diagram of an e-mail processing system according to one embodiment, and FIG. 2 is a block diagram of a client terminal device in FIG. 1. FIGS. 3 and 4 are sequences diagrams of e-mail acceptance operations and neglect alarm operations in FIGS. 1 and 2. FIG. 5 is an illustrative diagram of a display screen of an e-mail status in the client terminal device in FIG. 2, and FIG. 6 is an illustrative diagram of the header of a newly arrived e-mail in FIGS. 1 to 4. FIG. 7 is an illustrative diagram of the header of a reply e-mail in FIGS. 1 to 4, and FIG. 8 is an illustrative diagram of the header of a forward e-mail in FIGS. 1 to 4. A call center operation system is illustrated as an example of the e-mail processing system in FIG. 1. The call center operation system includes a mailing list server 3 and a plurality of call center systems 6A to 6C that are connected to the mailing list server 3. Each of the call center systems 6A to 6C includes an e-mail server 4 connected to the mailing list server 3 and a plurality of client terminal devices 1 connected to the e-mail server 4.

The mailing list server 3 is connected to a customer terminal device 5 via the internet/intranet 2 and communicates with the customer terminal device 5 to receive an inquiry e-mail from the customer terminal device 5.

In the call center operations, the mailing list server 3 identifies the mailing list that is to accept an inquiry e-mail and sends the inquiry e-mail to a personal e-mail address of each operator that is registered in the mailing list. Hereinafter, the e-mail address of the mailing list is referred to as a certain mailing list address. That is to say, the mailing list server 3 includes the certain mailing list addresses to be a destination and the mailing list where the personal e-mail addresses of operators are registered.

In FIG. 1, the plurality of call center systems are provided because the processing of the received e-mails is distributed among the call center systems 6A to 6C. The call center systems 6A to 6C may be located anywhere irrespective of the positional relation among the call center systems, as long as the call center systems 6A to 6C are connected to the network.

In addition, for example, the client terminal device 1 may be a personal computer that includes an e-mail client such as Outlook (registered trademark), Outlook Express (registered trademark), Thunderbird (registered trademark), or AL-Mail (registered trademark). The e-mail server 4 is connected to a plurality of client terminal devices 1 and includes a mailbox to store e-mails.

The operation of the e-mail processing system in FIG. 1 is described below. The customer terminal device 5 sends the inquiry e-mail to the certain mailing list address via the internet/intranet 2. After that, the sent inquiry e-mail is received by the mailing list server 3. The mailing list server 3 broadcasts the received inquiry e-mail to the e-mail addresses registered in the certain mailing list address. When the mailing list server 3 broadcasts the received inquiry e-mail to the certain mailing list address, the mailing list server 3 selects the most suitable e-mail server 4 and sends the received inquiry e-mail to the selected e-mail server 4.

After that, each of the client terminal devices 1 receives the e-mails stored in the mailbox of the e-mail server 4 at a certain time interval using Post Office Protocol (POP) for download of e-mails, for example.

The client terminal device 1 is described with reference to FIG. 2. The client terminal device 1 includes hardware resources such as a network adapter, a central processing unit (CPU), a memory, a hard disk drive (HDD), a display, a keyboard, and a mouse.

The client terminal device 1 includes an e-mail receiving unit 10 that receives e-mails, an e-mail sending unit 16 that sends e-mails, a memory 12 that stores the received e-mails and the sent e-mails, an operation control unit 14 that processes a display of a regular e-mail and a display of an e-mail associated with the call center operations, etc., and an input unit 18 for creation of an e-mail that includes the keyboard and the mouse, etc., for example.

The operation control unit 14 is a function unit that is performed by the CPU and includes a screen generating unit 20 and a display unit 22 for the display. The e-mail receiving unit 10 and the e-mail sending unit 16 are function units that are performed by the CPU and the network adapter. For example, the e-mail receiving unit 10 and the e-mail sending unit 16 may be performed by software, such as Outlook Express (registered trademark), for e-mail communication in accordance with the SMTP protocol.

In the embodiment, the client terminal device 1 includes a program that associates a newly arrived e-mail, a forward e-mail, and a reply e-mail with the call center operations using a Message-ID header, an In-Reply-To header, and a Reference header for the SMTP protocol. The program determines that an inquiry e-mail is an accepted e-mail when the inquiry e-mail has been forwarded or determines that the inquiry e-mail is a reply e-mail when the inquiry e-mail has been replied to, and changes the display status in the e-mail client. The operator may take a next action by recognizing (e.g., visually) the changing of the display status. Stated differently, the category of an email may be determined using the Message-ID header, the In-Reply-To header, and the Reference header. The categories of the email refer to whether the email is a newly-arrived e-mail, a forward e-mail, a reply e-mail, an inquiry e-mail, or accepted e-mail. Further, the display status of an e-mail changes according to a determined category of an email.

The sequences in FIGS. 3 and 4 are described below with reference to FIGS. 5 to 8.

(Operation S10)

The customer terminal device 5 sends the inquiry e-mail to the certain mailing list address. When the inquiry e-mail is sent to the certain mailing list address, the mailing list server 3 broadcasts the inquiry e-mail to the client terminal devices 1 (a terminal device 1, 2, and 3 in the call center system in FIG. 3) registered in the mailing list using a mailing list server function.

After the client terminal device 1 stores the e-mail in the memory 12, which is received from the e-mail server 4 (see FIG. 2) at a certain time interval using the POP protocol, the client terminal device 1 displays the presence of the received e-mail on an inbox of the display screen of the e-mail. FIG. 5 illustrates the screen of the inbox in the client terminal device 1. The screen of the inbox is displayed on a thread basis by the e-mail client function using the Message-ID header, the In-Reply-To header, and the Reference header for the SMTP protocol. From the Message-ID header (Message-ID: AAAA) illustrated in FIG. 6, the operation control unit 14 in the client terminal device 1 identifies the received e-mail as a newly arrived e-mail and determines whether the destination of the newly arrived e-mail is directed to the certain mailing list address. When the destination of the newly arrived e-mail is not directed to the certain mailing list address, the newly arrived e-mail is dealt with as a regular e-mail. On the other hand, when the destination of the newly arrived e-mail is directed to the certain mailing list address, the display color of the newly arrived e-mail on the screen is displayed differently from the display of the regular e-mail. For example, the color of the newly arrived e-mail on the screen may be displayed in a different color than the regular e-mail. For example, the regular e-mail may be displayed in black and the newly arrived e-mail may be displayed in blue. In addition, an acceptance button for the newly arrived e-mail is displayed on the screen.

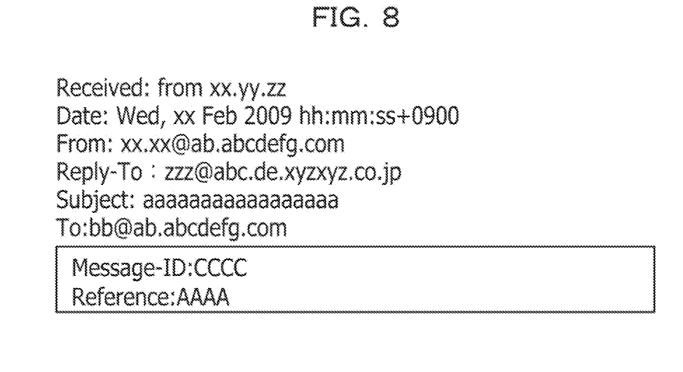

As illustrated in FIG. 6, an e-mail includes e-mail headers such as “Received” that indicates tracking information generated by e-mail servers, “Date” that indicates the time and date when the e-mail was sent by sender, “From” that indicates the e-mail address of the sender, “Reply-To” that indicates a destination e-mail address used to reply to the e-mail, “Subject” that indicates a title of the e-mail, “To” that indicates a destination e-mail address of the e-mail recipient, etc., and a message area. In a newly arrived e-mail, the Message-ID header is merely added to the message area as illustrated in FIG. 6. In addition, as illustrated in FIG. 7, a reply e-mail includes similar e-mail headers and message area to the e-mail in FIG. 6 and the In-Reply-To header and the References header are newly added to the message area of the reply e-mail. Similarly, as illustrated in FIG. 8, a forward e-mail includes similar e-mail headers and message area to the e-mail in FIG. 6 and the References header is newly added to the message area of the forward e-mail. The e-mail format may be in accordance with the SMTP protocol.

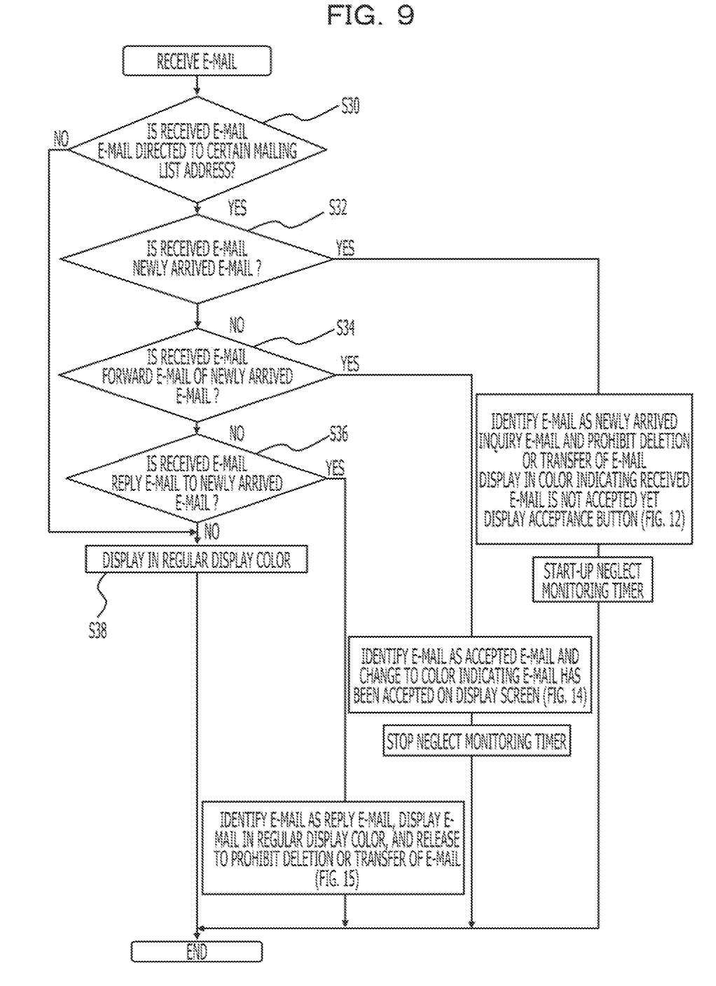

The determination of whether the e-mail is a newly arrived e-mail is performed by interpreting the Message-ID header that is included in the e-mail header in FIG. 6. The operation control unit 14 restricts accessing to the newly arrived e-mail so that deletion or transfer of the e-mail from the inbox is prohibited. Unless the next action is taken, the newly arrived e-mail remains in the inbox. Thus, the operators may recognize that the there is a newly arrived e-mail and the reply to the newly arrived e-mail is unfinished. The above described operations are described in detail below with reference to drawings in FIGS. 9 to 16.

(Operation S12)

When the operator of the client terminal device 1 is one of recipients in the mailing list who have received the newly arrived e-mail that had been broadcasted and when the operator accepts (e.g., clicks the acceptance button using the mouse of the input unit 18), the operation control unit 14 sends the forward e-mail illustrated in FIG. 8 to the certain mailing list address.

(Operation S14)

The mailing list server 3 broadcasts (forwards) the forward e-mail to the client terminal devices 1 (a terminal device 1, 2, and 3 in the call center system in FIG. 3) of the recipients (operators) who are registered in the mailing list. The client terminal device 1 of each of the operators stores the received e-mail in the memory 12 and the operation control unit 14 determines based on the headers in FIGS. 6 to 8 (the Message-ID header, the In-Reply-To header, the Reference header) in accordance with the SMTP protocol whether the received e-mail is the forward e-mail directed to the certain mailing list address. When the operation control unit 14 determines that received e-mail is the forward e-mail directed to the certain mailing list address, the received e-mail is identified as the accepted e-mail and the display (e.g., color) of the received e-mail in the inbox changes to the display indicating that the received e-mail has been accepted. For example, the display color of the accepted e-mail may be light blue.

(Operation S16)

When the operator replies to the accepted e-mail using the input unit 18 such as the keyboard and the mouse in the client terminal device 1, the reply e-mail as illustrated in FIG. 7 is sent to the client terminal device 1 of each of the operators and the customer terminal device 5 from the mailing list server 3. The operation control unit 14 in the client terminal device 1 determines that the received e-mail is the reply e-mail to the accepted e-mail because the value of the Message-ID header of the accepted e-mail is stored in the In-Reply-To header (see FIG. 7). When the operation control unit 14 determines that the received e-mail is the reply e-mail to the accepted e-mail, the operation control unit 14 recognizes that the reply has been conducted to the inquiry e-mail and further determines that the acceptance operations has been finished. Accordingly, the operation control unit 14 changes the display (e.g., color) of the replied to e-mail to the regular display (e.g., regular display color) and releases the restriction on the access to the inquiry e-mail so that the deletion or transfer of the e-mail from the inbox is permitted.

(Operation S20)

In FIG. 4, the operation control unit 14 in the client terminal device 1 of each of the operators starts time-monitoring after the acceptance button for the newly arrived e-mail is displayed in Operation S10 of FIG. 3. The operation control unit 14 determines that the newly arrived e-mail is not yet accepted when an e-mail that may be identified as the forward e-mail of the newly arrived e-mail has not been received within a certain time period (for example, five minutes, ten minutes, or the like). In addition, the operation control unit 14 may change the display color of the e-mail to a color of warning as alarm, for example, after the five minutes have passed, and may change the display color of the e-mail to a color of alert as alarm, for example, after the ten minutes have passed. For example, the color of the warning may be orange-red and the color of the alert may be red.

The function that keeps track of the acceptance operations and reply operations of the inquiry e-mail may be simply performed by the e-mail client without changing the e-mail server or the mailing list server. Thus a general-purpose and reasonable call center operation system may be developed and constructed. In addition, the system may be added to the commercially available e-mail client such as Outlook (registered trademark) or Outlook Express (registered trademark) because the system is made up of additional functions. A manager as well as the operators in the call center may keep track of the acceptance operations and the reply operations of the inquiry e-mail from the customer using the similar system without constructing an extra system.

[E-Mail Processing Method]

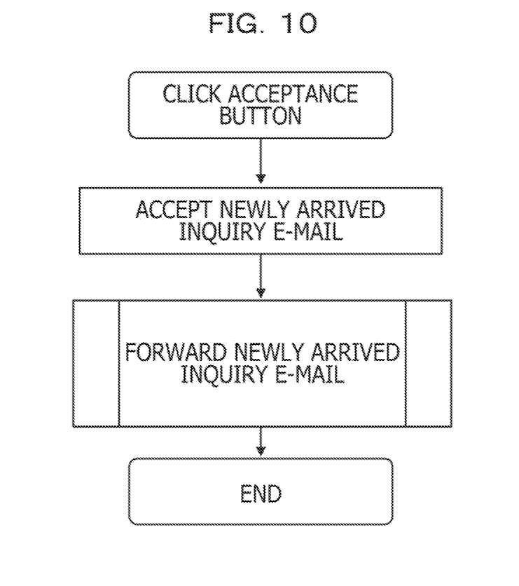

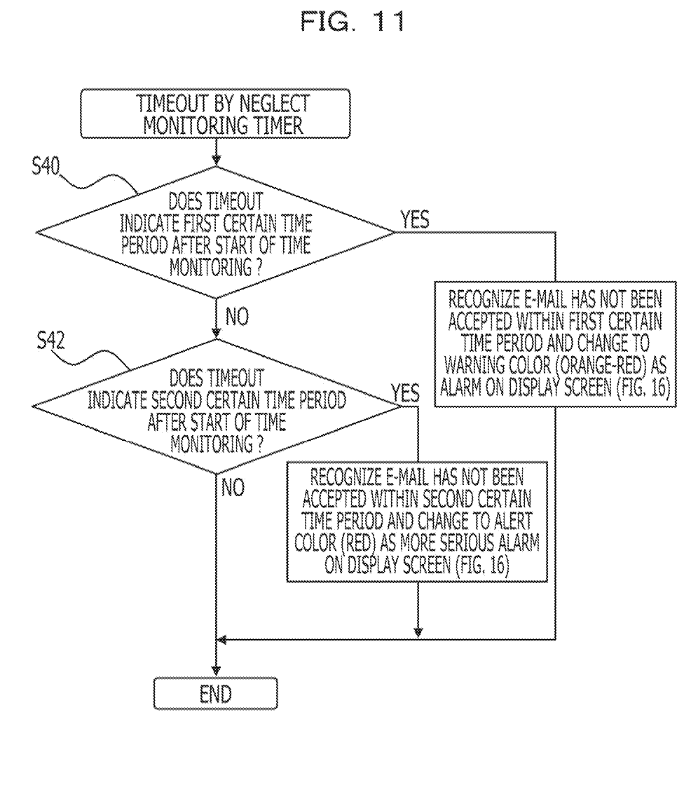

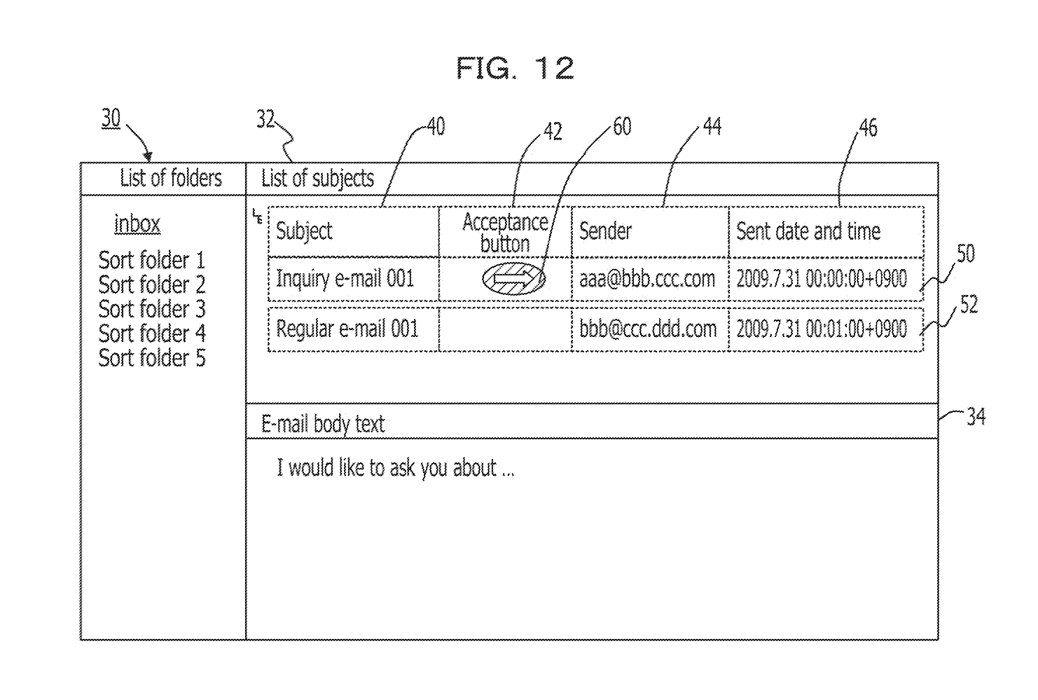

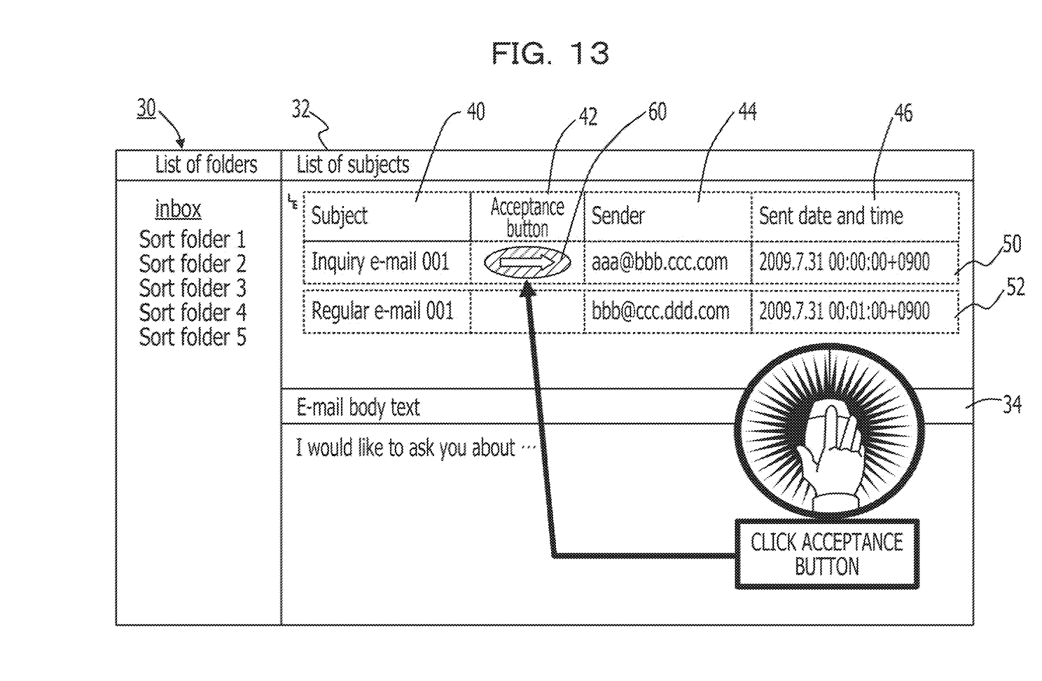

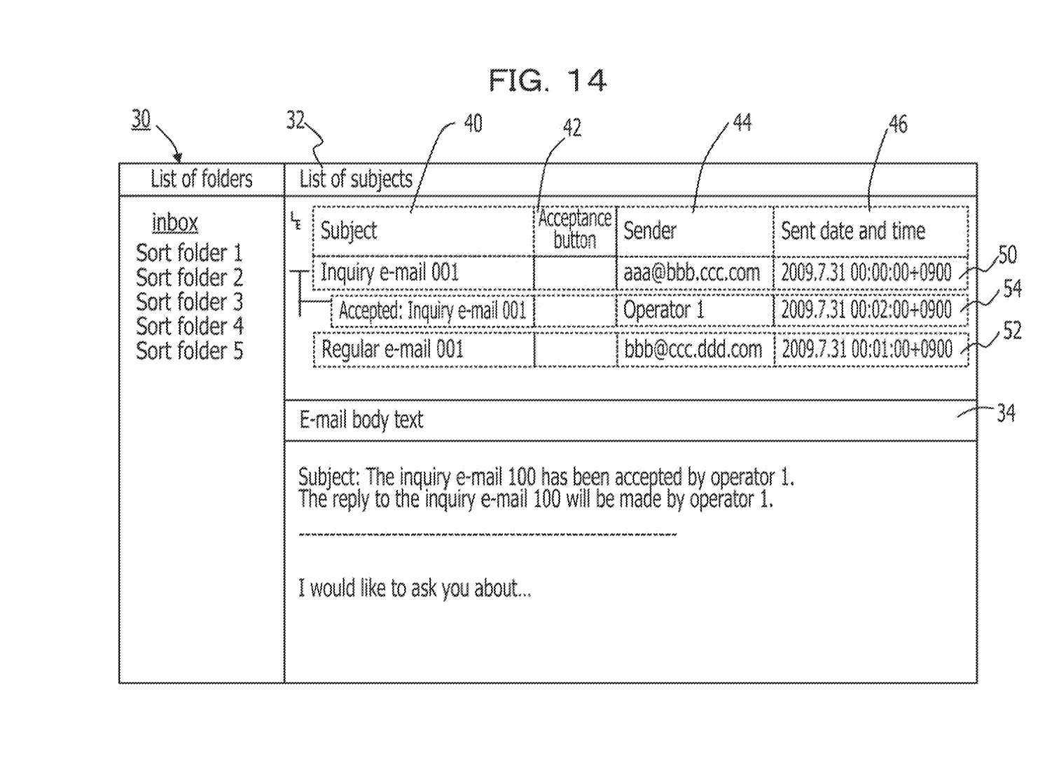

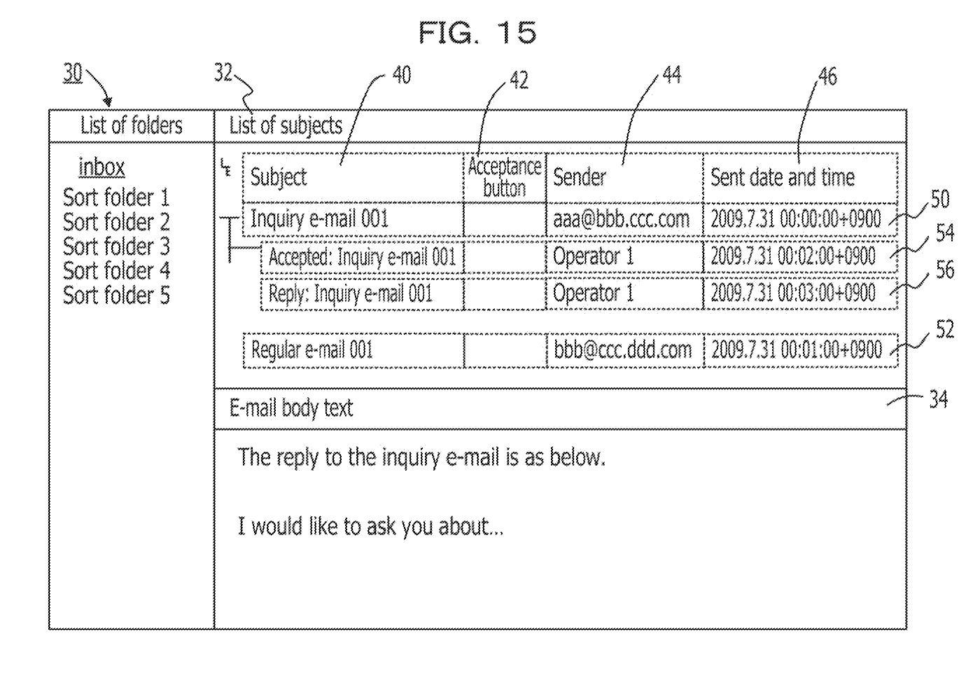

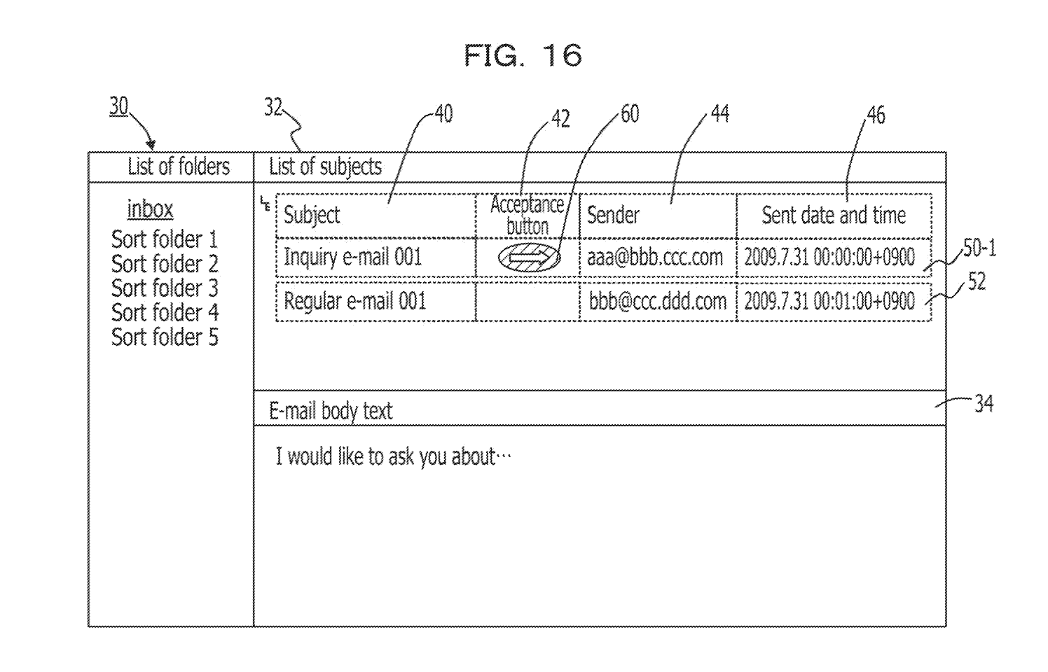

An e-mail processing method in the client terminal device 1 is described below with reference to FIGS. 9 to 16. FIG. 9 is a flowchart of e-mail reception operations according to the embodiment. FIG. 10 is a flowchart of operations when an acceptance button is clicked according to the embodiment. FIG. 11 is a flowchart of neglect timer operations in FIG. 9. FIG. 12 is an illustrative diagram of a display screen of a newly arrived e-mail in FIG. 9. FIG. 13 is an illustrative diagram of the clicking of the acceptance button in FIG. 10. FIG. 14 is an illustrative diagram of a display screen of an acceptance confirmation e-mail. FIG. 15 is an illustrative diagram of a display screen of a reply e-mail in FIG. 9. FIG. 16 is an illustrative diagram of a display screen of request for the acceptance operations in FIGS. 9 and 11. The e-mail reception operations of the email-processing method illustrated in FIG. 9 are described below with reference to FIGS. 10 to 16.

(Operation S30)

The operation control unit 14 in the client terminal device 1 stores the e-mail received from the e-mail server 4 (see FIG. 2) in the memory 12 via the e-mail receiving unit 10 using the POP protocol, and determines whether the received e-mail is the email directed to the certain mailing list address.

(Operation S32)

When the operation control unit 14 determines the received e-mail is the e-mail directed to the certain mailing list address, the operation control unit 14 further determines whether the received e-mail is a newly arrived e-mail. As described above, the operation control unit 14 in the client terminal device 1 determines whether the received e-mail is the newly arrived e-mail according to the Message ID header (Message-ID: AAAA) in FIG. 6. When the operation control unit 14 determines the received e-mail is the newly arrived e-mail, the operation control unit 14 displays the newly arrived e-mail in a different color from the display color of the regular e-mail on the screen, for example. In addition, the operation control unit 14 displays an acceptance button for the newly arrived e-mail on the screen. As illustrated in FIG. 12, a received e-mail display screen 30 includes a list of subjects 32 and an e-mail body text area 34. In the embodiment, the list of subjects 32 is provided with an acceptance button display area 42 in addition to a subject 40, a sender 44, a sent date and time 46, and the like in each of the received e-mails. For example, the display color of the regular e-mail 52 may be black, the display color of the newly arrived e-mail 50 may be blue, and the display color of the acceptance button 60 in the acceptance button display area 42 for the newly arrived e-mail 50 may be red in the received e-mail display screen 30. Moreover, the operation control unit 14 starts up a neglect monitoring timer according to the reception operations for the newly arrived e-mail 50.

(Operation S34)

On the other hand, when the operation control unit 14 determines the received e-mail is not the newly arrived e-mail, the operation control unit 14 further determines whether the received e-mail is the forward e-mail of the newly arrived e-mail. Forward e-mail sending operations are described below with reference to FIGS. 10 and 13. As illustrated in FIGS. 10 and 13, when the one of operators operating the client terminal device 1 receives the newly arrived e-mail as the broadcasted e-mail and clicks the acceptance button 60 that is displayed in the acceptance button display area 42 for the newly arrived e-mail 50 as an icon in the received e-mail display screen 30 of FIG. 12, the operation control unit 14 completes acceptance of the newly arrived inquiry e-mail and performs a sending operation for forwarding the newly arrived e-mail to the mailing list server 3 as the forward e-mail (see FIG. 8).

The mailing list server 3 broadcasts (forwards) the forward e-mail to the client terminal devices 1 registered in the mailing list. The client terminal device 1 of each of the operators stores the e-mail received from the mailing list server 3 in the memory 12, and the operation control unit 14 determines whether the received e-mail is the forward e-mail directed to the certain mailing list address based on the headers in FIGS. 6 to 8 (the Message-ID header, the In-Reply-To header, and the Reference header) in accordance with the SMTP protocol.

When the operation control unit 14 determines that the received e-mail is the forward e-mail, the operation control unit 14 recognizes that the inquiry e-mail has been accepted and displays an accepted: inquiry e-mail 54 that is the forward e-mail under the newly arrived e-mail (inquiry e-mail) 50 as illustrated in FIG. 14. After that, the operation control unit 14 stops the neglect monitoring timer, changes the display color of the inquiry e-mail to regular color (for example, black), and removes the acceptance button 60 from the acceptance button display area 42. The “Accepted: Inquiry e-mail 001” 54 is displayed in different color that indicates “accepted” state from the display color of the inquiry e-mail 50 in the received e-mail display screen 30. For example, the display color of the “accepted” state may be light blue.

(Operation S36)

On the other hand, when the operation control unit 14 determines that the received e-mail is not the forward e-mail, the operation control unit 14 further determines whether the received e-mail is the reply e-mail. As described above, when the operator replies to the accepted e-mail using the input unit 18 including the keyboard, mouse, etc., in the client terminal device 1, the reply e-mail as illustrated in FIG. 7 is sent to the client terminal device 1 of each of the operators and the customer terminal device 5 from the mailing list server 3. The operation control unit 14 in the client terminal device 1 determines that the sent e-mail is the reply e-mail to the accepted e-mail because the value of the Message-ID header of the accepted e-mail is stored in the In-Reply-To header (see FIG. 7).

When the operation control unit 14 determines that the received e-mail is the reply e-mail, the operation control unit 14 recognizes the inquiry e-mail has been replied and further determines the acceptance operations have finished. Accordingly, as illustrated in FIG. 15, the operation control unit 14 displays a “Reply: Inquiry e-mail 001” 56 in the regular display color under the inquiry e-mail 50 and the “Accepted: Inquiry e-mail 001” 54. In addition, the operation control unit 14 also displays the “Accepted: Inquiry e-mail 001” 54 in the regular display color and releases the restriction on the access to the inquiry e-mail so that deletion, transfer, or the like of the e-mail from the inbox is permitted.

(Operation S38)

When the operation control unit 14 determines that the received e-mail is not directed to the certain mailing list address in Operation S30 or that the received e-mail is not the reply e-mail to the newly arrived e-mail in Operation S36, the operation control unit 14 displays the received e-mail as normal display. For example, the received e-mail may be display in the regular color similar to the regular e-mail 52 in FIG. 12.

The neglect monitoring timer is described below with reference to FIGS. 11 and 16.

(Operation S40)

In Operation 32 of FIG. 9, the operation control unit 14 in the client terminal device 1 of each of the operators starts time-monitoring by the neglect monitoring timer after the newly arrived e-mail has been received and the acceptance button 60 has been displayed. After that, the operation control unit 14 starts timeout interrupt operations. That is to say, when an e-mail that may be identified as the forward e-mail of the newly arrived e-mail has not been received within a first certain time period (for example, five minutes) from the start of the time monitoring in the client terminal device 1 as illustrated in FIG. 16, the operation control unit 14 determines that a first timeout (the state where the e-mail is not accepted yet) has occurred and changes the display color of the newly arrived e-mail 50-1 to the color of warning (for example, orange-red) as an alarm.

(Operation S42)

When the operation control unit 14 determines that the first timeout has not occurred, the operation control unit 14 further determines whether a second timeout has occurred. When the operation control unit 14 determines that the second timeout has occurred, that is, the e-mail that may be identified as the forward e-mail of the newly arrived e-mail has not been received within the second certain time period (for example, ten minutes) from the start of the time-monitoring in the client terminal device 1, as illustrated in FIG. 16, the operation control unit 14 changes the display color of the newly arrived e-mail 50-1 to the color of alert (for example, red) as a more serious alarm.

The acceptance operations may be simply operated using a pointing device as the mouse because the acceptance button is displayed as the icon in the acceptance button display area 42 as described above. In addition, various e-mails received by the operators may be simply distinguished by changing the display colors of the newly arrived e-mail, the forward e-mail, and the reply e-mail respectively. Moreover, the prolonged neglect of newly arrived e-mail that is not accepted yet by the operators may be reduced if not prevented by alarm-displaying the neglected e-mail.

The example where the two timers of five minute and ten minutes are employed is described above with reference to FIGS. 11 and 16. Alternatively, for example, the timeout interrupt operation is performed at intervals of about five minutes using a single timer and then the arrival of the certain time periods (for example, five minutes, ten minute, etc.) may be determined according to the number of occurrences of the timeout interrupt operation. In this case, when the operation control unit 14 determines that the second timeout has not occurred in Operation S42, it is desirable that the timer is stopped.

### Another Embodiment

In the above-described embodiment, the display colors of the newly arrived e-mail, the forward e-mail, and the reply e-mail are different from each other. Alternatively, for example, the distinction of the e-mails may be made by changing the display character style (e.g., a font, bold face, italic face, an underline, etc.), shaded text, or the like. In addition, another display style may be employed instead of the display of the acceptance button 60 and the e-mail format may not be limited to the SMTP protocol.

The invention has been described with reference to the embodiments, but many modifications may be made without departing from the spirit and scope of the invention. Accordingly, these modifications are considered to be within the scope of the invention.

All examples and conditional language recited herein are intended for pedagogical purposes to aid the reader in understanding the aspects of the invention and the concepts contributed by the inventors to furthering the art, and are to be construed as being without limitation to such specifically recited examples and conditions, nor does the organization of such examples in the specification relate to a showing of the superiority and inferiority of the aspects of the invention. Although the embodiment in accordance with aspects of the present invention has been described in detail, it should be understood that various changes, substitutions, and alterations could be made hereto without departing from the spirit and scope of the invention.

What is claimed is:

1. An e-mail processing system including a terminal device registered in a mailing list, and an e-mail delivery device that forwards a received e-mail directed to a mailing list address registered in the mailing list, the terminal device comprising:
an identification unit that identifies a category of the forwarded e-mail from the e-mail delivery device based on information included in the forwarded e-mail;
a display unit that displays the forwarded e-mail; and
a control unit that determines a display mode of the forwarded e-mail in the display unit based on the identified category of the forwarded e-mail.

2. The e-mail processing system according to claim 1, wherein
when the forwarded e-mail is identified as an e-mail forwarded from the e-mail delivery device and initially received by a terminal device corresponding to the identification unit, the control unit displays the identified e-mail on the display unit and forwards the identified e-mail through the e-mail delivery device based on an inputted instruction.

3. The e-mail processing system according to claim 1, wherein
when the forwarded e-mail is identified as an e-mail forwarded from the e-mail delivery device and initially received by a terminal device corresponding to the identification unit, the control unit starts a timer, and
when a reply e-mail to the forwarded e-mail is not received within a first time period from the start of the timer, the control unit changes the display mode of the forwarded e-mail on the display unit.

4. The e-mail processing system according to claim 3, wherein
when the forwarded e-mail is identified as an e-mail forwarded from the e-mail delivery device and initially received by the terminal device corresponding to the identification unit, the control unit prohibits deletion or transfer of the forwarded e-mail from a reception memory of the terminal device corresponding to the identification unit, and
when the forwarded e-mail is identified as the reply e-mail to the forwarded e-mail, the control unit releases prohibition of the deletion or the transfer of the forwarded e-mail from the reception memory of the terminal device corresponding to the identification unit.

5. The e-mail processing system according to claim 3, wherein
when the reply e-mail to the forwarded e-mail is not received within the first time period from the start of the timer, the control unit displays the forwarded e-mail on the display unit in a first display mode, and
when the reply e-mail to the forwarded e-mail is not received within a second time period that is longer than the first certain time period from the start of the timer, the control unit displays the forwarded e-mail on the display unit in a second display mode different from the first display mode.

6. An e-mail processing method performed in a terminal device that receives a forwarded e-mail forwarded to a mailing list address by an e-mail delivery device, and is registered in a mailing list, the e-mail processing method comprising:
identifying a category of the forwarded e-mail from the e-mail delivery device based on information included in the forwarded e-mail; and
determining a display mode of the forwarded email on a display unit based on the identified category of the forwarded e-mail.

7. The e-mail processing method according to claim 6, further comprising:
displaying the forwarded e-mail on the display unit;
forwarding the forwarded e-mail based on an inputted instruction when the forwarded e-mail is identified based on the identified category as an e-mail forwarded from the e-mail delivery device and initially received by the terminal device that is registered in the mailing list and identifies the forwarded e-mail.

8. The e-mail processing method according to claim 6, further comprising:
starting a timer when the forwarded e-mail is identified as an e-mail forwarded from the e-mail delivery device and initially received by the terminal device that is registered in the mailing list and identifies the forwarded e-mail; and
changing the display mode of the forwarded e-mail on the display unit when a reply e-mail to the forwarded e-mail is not received within a first time period from the start of the timer.

9. The e-mail processing method according to claim 8, further comprising:
prohibiting deletion or transfer of the forwarded e-mail from a reception memory of the terminal device that identifies the forwarded e-mail when the forwarded e-mail is identified as an e-mail forwarded from the e-mail delivery device and initially received by the terminal device; and
releasing prohibition of the deletion or the transfer of the forwarded e-mail from the reception memory of the terminal device when the forwarded e-mail is identified as the reply e-mail to the terminal device.

10. The e-mail processing method according to claim 8, further comprising:
displaying the forwarded e-mail on the display unit in a first display mode when the reply e-mail to the forwarded e-mail is not received within the first time period from the start of the timer; and
displaying the forwarded e-mail on the display unit in a second display mode different from the first display mode when the reply e-mail to the forwarded e-mail is not received within a second time period that is longer than the first certain time period from the start of the timer.

11. A computer-readable recording medium configured to store an e-mail processing program in a computer that receives a forwarded e-mail to a mailing list address by an e-mail delivery device, and is registered in a mailing list, the e-mail processing program causing the computer to execute:
identifying a category of the forwarded e-mail from the e-mail delivery device based on information included in the forwarded e-mail; and
determining a display mode of the forwarded email on a display unit based on the identified category of the forwarded e-mail.

12. The computer-readable recording medium according to claim 11, wherein
the e-mail processing program causes the computer to further execute:
displaying the forwarded e-mail on the display unit;
forwarding the forwarded e-mail based on an inputted instruction when the forwarded e-mail is identified based on the identified category as an e-mail forwarded from the e-mail delivery device and initially received by the computer that is registered in the mailing list and identifies the forwarded e-mail.

13. The computer-readable recording medium according to claim 11, wherein
the e-mail processing program causes the computer to further execute:
starting a timer when the forwarded e-mail is identified as an e-mail forwarded from the e-mail delivery device and initially received by the computer that is registered in the mailing list and identifies the forwarded e-mail; and
changing the display mode of the forwarded e-mail on the display unit when a reply e-mail to the forwarded e-mail is not received within a first time period from the start of the timer.

14. The computer-readable recording medium according to claim 13, wherein
the e-mail processing program causes the computer to further execute:
prohibiting deletion or transfer of the forwarded e-mail from a reception memory of the computer that identifies the forwarded e-mail when the forwarded e-mail is identified as an e-mail forwarded from the e-mail delivery device and initially received by the computer; and
releasing prohibition of the deletion or the transfer of the forwarded e-mail from the reception memory of the computer when the forwarded e-mail is identified as the reply e-mail to the computer.

15. The computer-readable recording medium according to claim 13, wherein
the e-mail processing program causes the computer to further execute:
displaying the forwarded e-mail on the display unit in a first display mode when the reply e-mail to the forwarded e-mail is not received within the first time period from the start of the timer; and
displaying the forwarded e-mail on the display unit in a second display mode different from the first display mode when the reply e-mail to the forwarded e-mail is not received within a second time period that is longer than the first certain time period from the start of the timer.
